(19) United States
(12) Patent Application Publication
(10) Pub. No.: US 2021/0103954 A1
(43) Pub. Date: Apr. 8, 2021

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventors: Kana MIYAZAKI, Kanagawa (JP); Kengo TOKUCHI, Kanagawa (JP)

(73) Assignee: FUJI XEROX CO., LTD., Tokyo (JP)

(21) Appl. No.: 16/846,389

(22) Filed: Apr. 12, 2020

(30) Foreign Application Priority Data
Oct. 7, 2019 (JP) 2019-184823

(51) Int. Cl. G06Q 30/02; H04W 4/021; H04W 4/029; G09F 27/00

(52) U.S. Cl. CPC G06Q 30/0259; G06Q 30/0261; G09F 2027/001; H04W 4/029; G09F 27/005; H04W 4/021

(57) ABSTRACT

An information processing apparatus includes: a processor configured to acquire place information as information on a place where an output device that outputs information is installed; and determine a content of processing executed in a case where the output device outputs information or a content of processing executed in a case where information is input to the output device based on the place information.

### CROSS-REFERENCE TO RELATED APPLICATIONS

This application is based on and claims priority under 35 USC 119 from Japanese Patent Application No. 2019-184823 filed Oct. 7, 2019.

### BACKGROUND

### (i) Technical Field

The present invention relates to an information processing apparatus and a non-transitory computer readable medium storing a program.

### (ii) Related Art

For example, JP2013-117603A discloses a digital signage apparatus that receives, from an external apparatus, position information by which an installation position of the digital signage apparatus can be specified, inquires distribution of a content associated with the installation position by notifying an external information processing apparatus of the received position information, receives the content distributed by the inquiry, and plays the received content.

### SUMMARY

For example, a display such as a digital signage may be used to output information or to receive input of information. Such devices are installed in various places. On the other hand, it is considered that required processing contents vary depending on the places.

Aspects of non-limiting embodiments of the present disclosure relate to an information processing apparatus and a non-transitory computer readable medium storing a program that can vary a content of processing executed in a case where information is output or a content of processing executed in a case where information is input, depending on a place where a device is installed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus includes: a processor configured to acquire place information as information on a place where an output device that outputs information is installed; and determine a content of processing executed in a case where the output device outputs information or a content of processing executed in a case where information is input to the output device based on the place information.

### BRIEF DESCRIPTION OF THE DRAWINGS

Exemplary embodiment (s) of the present invention will be described in detail based on the following figures, wherein:

FIG. 1 is a diagram schematically illustrating an example of an overall configuration of an information processing system according to this exemplary embodiment;

FIG. 2 is a diagram illustrating an example of an external configuration of a booth-shaped space;

FIG. 3 is a diagram illustrating an example of a hardware configuration of a space management server according to this exemplary embodiment;

FIG. 4 is a diagram illustrating an example of a hardware configuration of a monitor included in an output device according to this exemplary embodiment;

FIG. 5 is a diagram illustrating an example of a functional configuration of the space management server;

FIGS. 6A to 6D are diagrams illustrating an example of a place information table;

FIGS. 7A to 7C are diagrams illustrating an example of the place information table;

FIG. 8 is a flowchart illustrating an example of a procedure of processing performed by the space management server; and

FIGS. 9A and 9B are diagrams illustrating an example of the place information table.

### DETAILED DESCRIPTION

Hereinafter, an exemplary embodiment of the present invention will be described with reference to the drawings.

Overall Configuration of Information Processing System

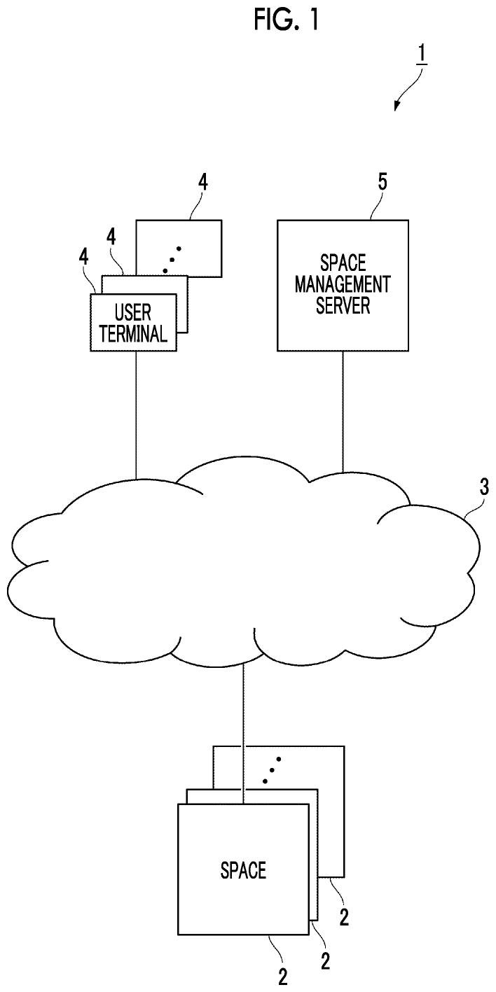

FIG. 1 is a diagram schematically illustrating an example of an overall configuration of an information processing system 1 according to this exemplary embodiment. The information processing system 1 according to this exemplary embodiment includes various apparatuses connected to a cloud network 3 and spaces 2.

The space 2 includes a booth, a guest room in an accommodation facility, a conference room in a company, and the like. In addition, the space 2 may be a movable place such as a car. These are examples of the space 2 separated from surroundings by walls, partitions, and the like. In addition, the space 2 includes a table, a seat, and the like that are provided for a service in a restaurant or the like. These are examples of the space open to surroundings. In this way, a form of the space 2 in this exemplary embodiment is not limited.

In addition, in this exemplary embodiment, a name, a number, or the like for management is assigned to the space 2. Further, in this exemplary embodiment, a plurality of spaces 2 may be provided, or one space 2 may be provided. In a case where the space 2 is used, a use fee may be free or charged.

In addition, in a case where an electronic lock is attached to a door of the space 2, the space 2 is used under a condition where a user has an electronic key distributed in advance. In a case of the space 2 having no door, for example, a method of authenticating a user using an authentication code distributed in advance, a method of checking a name of a user who uses the space 2 by an administrator of the space 2, or the like may be used.

In addition, in the example illustrated in FIG. 1, as examples of apparatuses connected to the cloud network 3, a user terminal 4 that is operated by a user and a space management server 5 that manages the space 2 are illustrated. Further, the spaces 2 are connected to the cloud network 3. More specifically, various devices are provided in the space 2, and the devices are connected to the cloud network 3.

Here, one company or a plurality of companies managing a certain space 2 may be provided. For example, management of reservations, management of use authority, management of entry/exit and indoor use statuses, management of billing of use fees to users, and management of members registered as users may be respectively shared by different companies. In addition, each space 2 may be managed by different companies.

Further, as described above, the spaces 2 managed as reservation targets do not need to be of the same type. For example, a part of the space 2 may be a booth, and a part of the space 2 may be a seat or a table of a restaurant or the like.

Further, management for one purpose or function may be provided by the plurality of companies in cooperation.

The user terminal 4 is an apparatus used by a user. In this exemplary embodiment, for example, it is assumed that the user terminal 4 is a smartphone which can be carried by a user. Here, the user terminal 4 may be a so-called wearable terminal, or may be a notebook computer or a game device.

The space management server 5 as an example of an information processing apparatus manages various information related to the space 2.

For example, the space management server 5 acquires information related to a place where an output device 24 to be described is installed (hereinafter, referred to as “place information”), and determines content of processing which is executed in a case where the output device 24 outputs information based on the acquired place information. The space management server 5 controls the output device 24 to output information with the determined content of the processing.

Further, the space management server 5 may manage reservation of articles and services associated with the space 2. For example, articles and services that can be rented or used and articles or services that are consumed or expended may be managed.

Although FIG. 1 illustrates only one apparatus as the space management server 5, a plurality of apparatuses may be provided. That is, the function of the space management server 5 may be realized by one apparatus, or the function of the space management server 5 may be realized by a plurality of apparatuses.

Configuration of Space

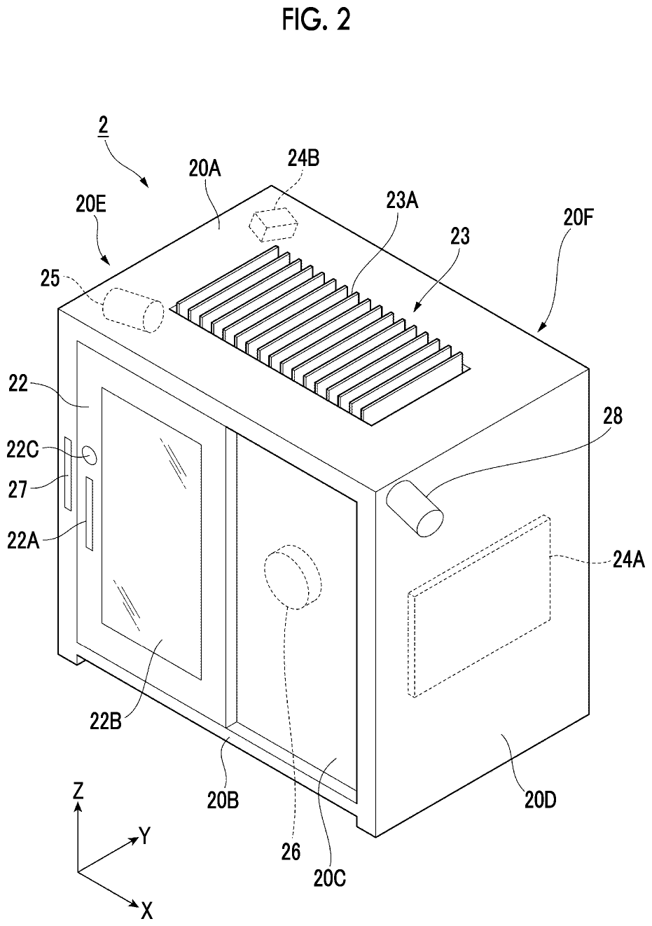

FIG. 2 is a diagram illustrating an example of an external configuration of the booth-shaped space 2.

The booth-shaped space 2 illustrated in FIG. 2 is provided at a place regardless of indoor and outdoor, for example, the inside of a station, an airport, an office building, a commercial facility such as a restaurant or a department store, a bank, a library, a gallery, a museum, a public institution or facility, a communication passage, a park, or the like.

The booth-shaped space 2 illustrated in FIG. 2 is a closed type booth to which a ceiling is attached. Here, the closed type booth does not mean an airtight booth, and may be a booth having practical soundproof performance. Thus, an opening or a gap such as a vent or a small window may be provided in a part of a body of the space 2. Further, the window may be opened and closed.

The body of the space 2 illustrated in FIG. 2 includes a ceiling 20A, a floor surface 20B, a wall surface 20C to which a door 22 is attached to be opened and closed, two wall surfaces 20D and 20E provided on both sides of the wall surface 20C, and a wall surface 20F provided on an opposite side of the door 22.

A ventilation opening 23 is provided in the ceiling 20A. A louver 23A of which the opening area is adjustable is provided in the ventilation opening 23. The louver 23A of FIG. 2 is in a fully opened state.

In this exemplary embodiment, as an example, it is assumed that the door 22 is a sliding door which can move along the wall surface 20C. In addition, in the example illustrated in FIG. 2, the door 22 is a single-sided sliding door that slides in one direction. On the other hand, the door 22 may be a double sliding door that is opened and closed by crossing two or more members with each other, or may be a drawer door that is opened and closed by sliding two members in a left and right direction. Further, a handle 22A that a user grips when opening and closing the door 22 is attached to the door 22. Furthermore, an electronic lock 22C that allows the door 22 to be unlocked and locked is attached to the door 22.

In addition, a member 22B obtained by performing machining in consideration of confidentiality and security is disposed in the center of the door 22. The member 22B may be, for example, a transparent plate in which a metal plate with a large number of arranged holes (for example, a punched metal) is attached to the inside, may be a transparent plate in which a member serving as a blind is attached to the inside with a gap, may be a transparent plate on which a film that allows the inside to be easily identified from the front and allows the inside to be unidentified from an oblique direction is coated, or may be a transparent plate in which machining for reducing viewability of the inside is performed. The machining may be performed on a part of the member 22B.

Here, the machining in consideration of confidentiality and security may be performed on members other than the door 22. For example, the machining in consideration of confidentiality and security may be performed on at least a part of the wall surfaces 20D, 20E, or 20F.

The number of users of the space 2 is approximatively determined by a volume of the space 2. It is assumed that the space 2 illustrated in FIG. 2 is a basic private room type space which is used by a small number of one to three persons. Here, the space 2 according to this exemplary embodiment may be a large room that can accommodate a large number of persons. The large room may be formed as a single room, or may be formed by connecting a plurality of spaces 2 from which one or both of the wall surfaces 20D and 20E of the space 2 are removed.

In addition, in the space 2, various equipment and devices are provided. As the devices, a monitor 24A as a display device for displaying images (in this exemplary embodiment, images including a moving image and a still image) and a speaker 24B as a sound output device for outputting a sound are provided. The speaker 24B may not be separately provided, and a speaker provided on the monitor 24A may output a sound. The monitor 24A is provided, for example, on a desk (not illustrated), by being embedded in the wall surfaces 20C to 20F, or by being hung from the ceiling 20A. Further, in the example illustrated in FIG. 2, although the monitor 24A and the speaker 24B are provided inside the body, the monitor 24A and the speaker 24B may be provided on an outer surface of the body. In a case where the monitor 24A and the speaker 24B are provided on the outer surface of the body, information is output to a person outside the space 2.

Hereinafter, the monitor 24A and the speaker 24B may be collectively referred to as an “output device 24”. In this exemplary embodiment, the output device 24 is an example of an output device that outputs information.

In addition, a place where the output device 24 is installed may be referred to as an “output device installation place”. In other words, the output device installation place can be regarded as the space 2. Here, since there are various places in the space 2, such as on a desk or an outer surface of the body, the output device installation place may be regarded as a specific place in the space 2.

In addition, an imaging device 25 configured by a camera or the like which images the inside of the body and a person detecting sensor 26 which detects a user inside the body are provided in the inside of the body.

Further, an information acquisition device 27 for acquiring personal information of a user who uses the space 2 is provided on the outer surface of the body. The information acquisition device 27 is configured by, for example, a reader that reads an ID card held by a user. In addition, the information acquisition device 27 may be a reader that reads a fingerprint of a user or arrangement of veins of a user.

Further, an imaging device 28 configured by a camera or the like which images the outside of the space 2 is provided on the outer surface of the body.

Further, although not illustrated in FIG. 2, other various sensors may be provided in order to collect the place information of the output device installation place. Examples of the various sensors include a global positioning system (GPS) sensor that receives a radio wave from a GPS satellite and measures a position of the space 2 or the output device 24, a sound collection microphone that is used to collect a sound inside the space 2, a sound collection microphone that is used to collect a sound outside the space 2, a temperature sensor that is used to measure a temperature inside the space 2, a temperature sensor that is used to measure a temperature outside the space 2, a humidity sensor that is used to measure a humidity level inside the space 2, a humidity sensor that is used to measure a humidity level outside the space 2, an environmental sensor that detects a component contained in air inside the space 2, an environmental sensor that detects a component contained in air outside the space 2, an acceleration sensor or a gyro sensor that detects a movement of an object, and the like. These various sensors may be provided in the output device 24.

The shape and the structure of the body of the space 2, the equipment provided in the space 2, and the performance of the space 2 may be changed, and are not limited to the configuration illustrated in FIG. 2. For example, a configuration in which the ceiling 20A is removed may also be adopted. Further, as described above, the space 2 may be a closed type booth, or may be an open type booth that is not closed toward the outside.

Hardware Configuration of Space Management Server

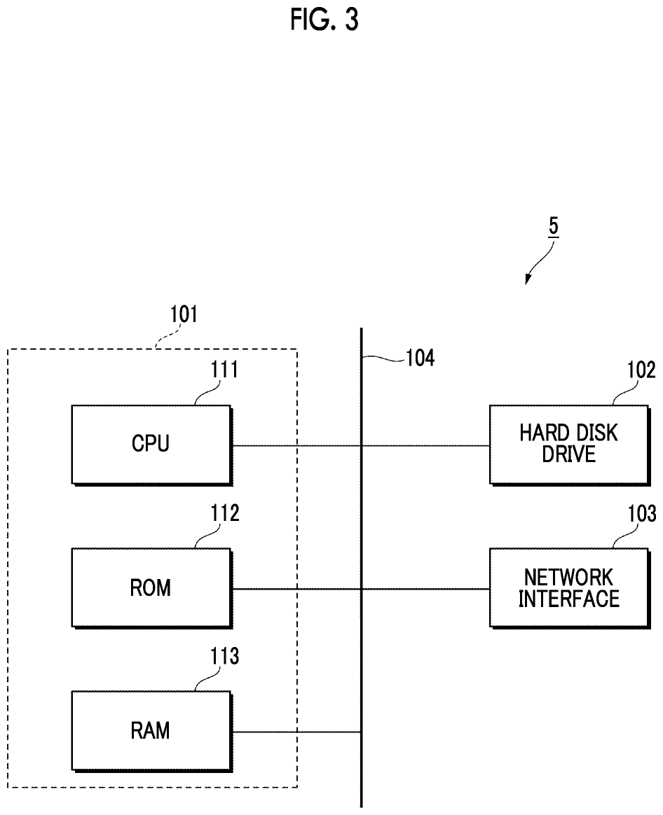

FIG. 3 is a diagram illustrating an example of a hardware configuration of the space management server 5 according to this exemplary embodiment.

The space management server 5 includes a control unit 101 that controls an operation of the entire space management server 5, a hard disk drive 102 that stores management data and the like, and a network interface 103 that performs communication via a local area network (LAN) cable or the like.

The control unit 101 includes a central processing unit (CPU) 111, a read only memory (ROM) 112 that stores basic software, a basic input output system (BIOS), and the like, and a random access memory (RAM) 113 that is used as a work area. The CPU 111 may be a multi-core type CPU. The ROM 112 may be a rewritable nonvolatile semiconductor memory. The control unit 101 is a so-called computer.

The hard disk drive 102 is a device that reads and writes data from and to a nonvolatile storage medium in which a magnetic material is applied on a front surface of a disk-shaped board. Here, the nonvolatile storage medium may be a semiconductor memory or a magnetic tape.

In addition, the space management server 5 includes an input device such as a keyboard and a mouse and a display device such as a liquid crystal display, as necessary.

The control unit 101, the hard disk drive 102, and the network interface 103 are connected to each other via a bus 104 or a signal line (not illustrated).

Hardware Configuration of Monitor

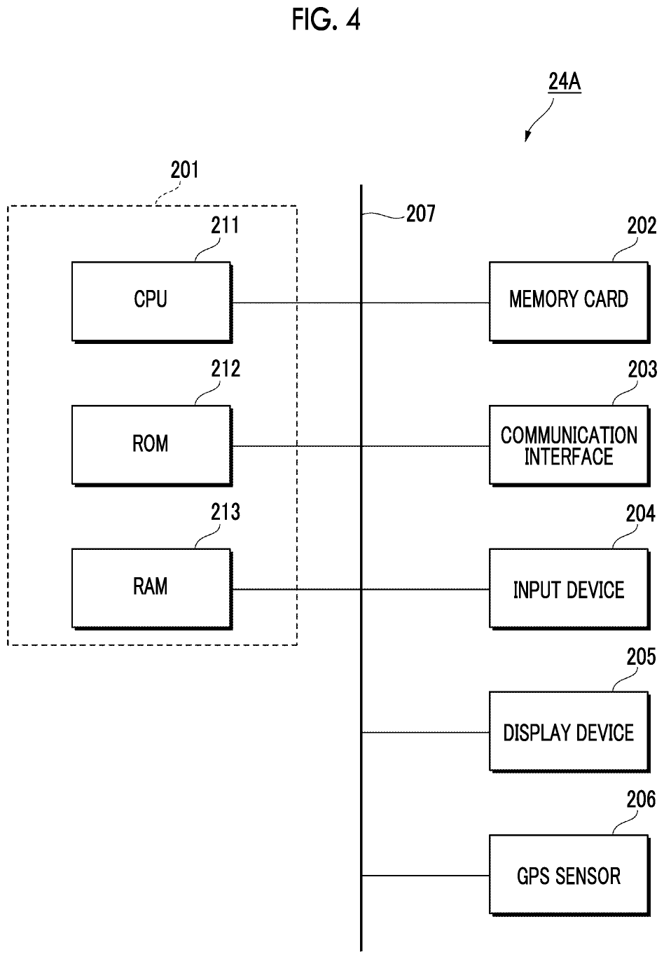

FIG. 4 is a diagram illustrating an example of a hardware configuration of the monitor 24A included in the output device 24 according to this exemplary embodiment.

The monitor 24A includes a control unit 201 that controls an operation of the entire monitor 24A, a memory card 202 that stores various data, a communication interface 203 that performs communication based on various wireless communication standards, an input device 204 such as a touch sensor, a display device 205 such as a liquid crystal display or an organic electro luminescence (EL) display, a GPS sensor 206, and a bus 207 that connects each unit.

The control unit 201 includes a CPU 211, a ROM 212 that stores firmware, BIOS, and the like, and a RAM 213 that is used as a work area. The CPU 211 may be a multi-core type CPU. The ROM 212 may be a rewritable nonvolatile semiconductor memory.

The communication interface 203 includes, for example, an interface used for connection with the space management server 5 and an interface used for connection with a wireless LAN.

The GPS sensor 206 is a sensor that receives a radio wave from a GPS satellite and measures a position of the output device 24. The current position of the output device 24 is determined based on latitude information, longitude information, and altitude information output from the GPS sensor 206. The GPS sensor 206 may correspond to an indoor positioning system.

Functional Configuration of Space Management Server

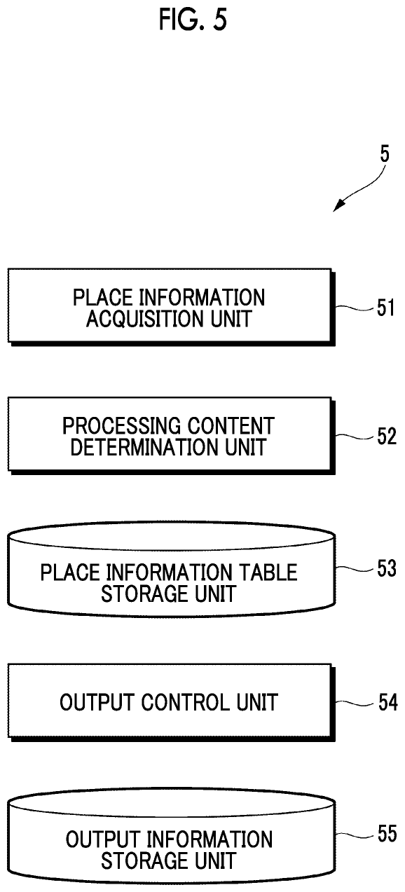

FIG. 5 is a diagram illustrating an example of a functional configuration of the space management server 5. The space management server 5 includes a place information acquisition unit 51, a processing content determination unit 52, a place information table storage unit 53, an output control unit 54, and an output information storage unit 55.

The place information acquisition unit 51 acquires place information of the output device installation place where the output device 24 is installed. Although details will be described later, the acquired place information is, for example, information on an environment around the output device installation place, information on a region to which the output device installation place belongs, or the like.

In other words, the place information is collected by various sensors such as the imaging device 25, the imaging device 28, and the sound collection microphone provided in the space 2, and is transmitted to the space management server 5. Further, for example, an imaging device may be provided at a position different from the position of the space 2, and information obtained by imaging the space 2 or the output device 24 using the imaging device may be used as the place information. Further, the place information may be information collected via the Internet, such as information on a temperature and weather of the output device installation place. Further, the place information may be information registered in the space management server 5 by a user, such as an address of the output device installation place.

The processing content determination unit 52 determines content of processing which is executed in a case where the output device 24 outputs information based on the place information acquired by the place information acquisition unit 51. Here, the processing content determination unit 52 determines content of processing which is executed in a case where the output device 24 outputs information by referring to a place information table stored in the place information table storage unit 53. Although details will be described later, the determined content of the processing includes, for example, the presence or absence of output of each of a sound and an image, content of processing for an output sound, content of processing for an output image, and the like.

The place information table storage unit 53 stores a place information table. The place information table is a table in which the place information is associated with the content of the processing executed in a case where the output device 24 outputs information. Details of the place information table will be described later.

The output control unit 54 controls output of information in the output device 24 based on the content of the processing that is determined by the processing content determination unit 52.

The output information storage unit 55 stores information which is output by the output device 24. Specifically, the information is content which is output by the output device 24. In other words, information such as a moving image, a still image, or a sound is stored.

Each functional unit of the space management server 5 is realized by cooperation of software and hardware resources. Specifically, in a case where the space management server 5 is realized by the hardware configuration illustrated in FIG. 3, for example, by reading a program stored in the hard disk drive 102 or the like into the RAM 113 and executing the program by the CPU 111, each functional unit such as the place information acquisition unit 51, the processing content determination unit 52, and the output control unit 54 is realized. Further, the place information table storage unit 53 and the output information storage unit 55 are realized by, for example, the hard disk drive 102.

Description of Place Information

Next, the place information will be described in detail with a specific example.

Information on Environment around Output Device Installation Place

As an example of the place information, information on an environment around the output device installation place is exemplified. Specifically, for example, as the information on an environment around the output device installation place, a volume level of a sound around the output device installation place, an amount of traffic around the output device installation place, a lightness/brightness level of the output device installation place, a temperature, a humidity level, and weather of the output device installation place, and the like are exemplified. Further, information on how high the output device 24 is installed from a point where the user is located, for example, information on a distance from the floor surface 20B of the space 2 to the output device 24 may be used as the place information.

Information on Region to which Output Device

### Installation Place Belongs

As an example of the place information, information on a region to which the output device installation place belongs is exemplified. Specifically, for example, as the region to which the output device installation place belongs, information such as a domestic region, an overseas region, or the like is exemplified. Further, for example, information indicating a type of the region to which the output device installation place belongs, such as an urban region, a residential region, or an industrial region may be included.

Information on Movement of Output Device Installation

Place

As an example of the place information, information on a movement of the output device installation place is exemplified. Specifically, for example, information such as the presence or absence of a movement of the output device installation place or a speed of a movement of the output device installation place is exemplified.

Information Indicating Attribute of Output Device Installation Place

As an example of the place information, information indicating an attribute of the output device installation place is exemplified. Specifically, for example, the attribute of the output device installation place is determined based on an address of the output device installation place or position information acquired by the GPS sensor. The attribute of the output device installation place may be assigned in advance for each output device installation place (or for each space 2).

As the attribute of the output device installation place, for example, information on a facility where the output device installation place is located, such as an office, a hospital, a school, a station, an airport, a department store, and the like. Further, for example, information on a road such as an expressway or a general road may be included.

Information on User Who Tends to be at Output Device Installation Place

As an example of the place information, information on a user who tends to be at the output device installation place is exemplified. Specifically, for example, information such as a tendency that there are many office workers, a tendency that there are many elderly persons, or a tendency that there are many foreigners is exemplified.

Here, what kind of user tends to be at the output device installation place is determined according to the output device installation place. For example, in a case where the output device installation place is an office, it is determined that there is a tendency that there are many office workers. For example, in a case where the output device installation place is in Sugamo, Tokyo, it is determined that there is a tendency that there are many elderly persons. For example, in a case where the output device installation place is a tourist spot for foreigners, it is determined that there is a tendency that there are many foreigners.

Further, for example, from a state of the inside of the space 2 imaged by the imaging device 25 and a state of the outside of the space 2 imaged by the imaging device 28, what kind of user tends to be at the output device installation place may be determined.

The users who tend to be at the output device installation place include not only users entering the space 2 but also users around the space 2.

Another Example of Place Information

The place information is not limited to the current information of the output device installation place, and may be information obtained by future prediction. Examples of the information obtained by future prediction include, for example, weather forecast information of the output device installation place.

Description of Processing Content

Next, the content of processing executed in a case where the output device 24 outputs information will be described in detail with a specific example.

As an example of the content of the processing, the presence or absence of output of each of a sound and an image is exemplified. Specifically, for example, outputting an image and a sound, outputting only an image, outputting only a sound, and the like are included.

Further, as an example of the content of the processing, the content of the processing for the output sound is exemplified. Specifically, as the content of the processing for the sound, for example, the presence or absence of sound output, a volume level of the output sound, pitch of the output sound, a play speed of the output sound, and the like are exemplified. In addition, the content of the processing for the sound may include content of processing for a language, such as outputting the sound in Japanese, and translating the sound from Japanese into a different language and outputting the translated sound.

Further, as an example of the content of the processing, the content of the processing for the output image is exemplified. Specifically, as the content of the processing for the image, for example, the presence or absence of image output, a brightness level of a screen (for example, a display area of the monitor 24A), a size of the screen, the number of divisions of the screen, a play speed of a moving image, and the like are exemplified. The number of divisions of the screen is the number of screen divisions, and includes, for example, two divisions, four divisions, and the like. In addition, as the content of the processing for the image, a size of a text included in a moving image or a still image may be determined. Further, as the content of the processing for the image, the presence or absence of a subtitle in Japanese or a foreign language may be determined.

Description of Place Information Table

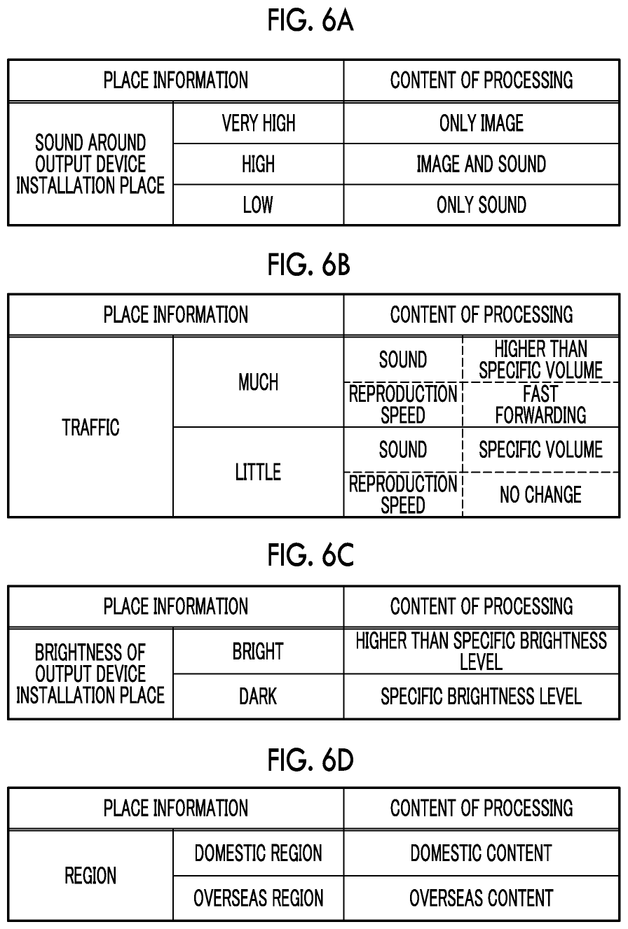

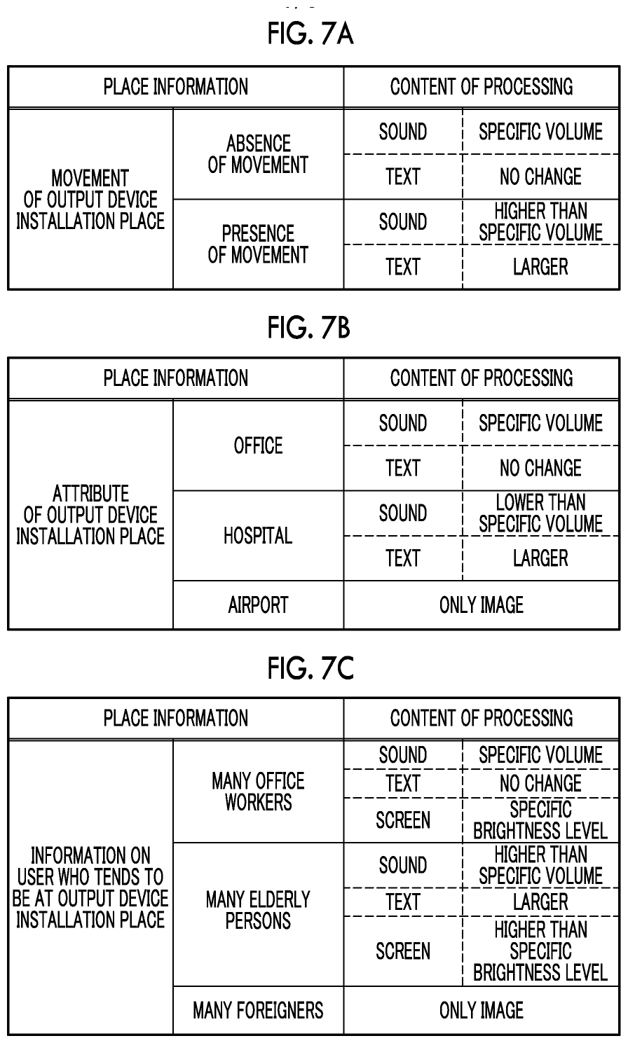

FIGS. 6A to 7C are diagrams illustrating an example of the place information table.

In the example illustrated in FIG. 6A, as the place information, information on the environment around the output device installation place, specifically, a volume level of the sound around the output device installation place is determined. Further, as the content of the processing, the presence or absence of output of each of the sound and the image is determined.

More specifically, outputting only the image is determined in a case where a volume level of the sound around the output device installation place is very high, outputting the image and the sound is determined in a case where a volume level of the sound around the output device installation place is high, and outputting only the sound is determined in a case where a volume level of the sound around the output device installation place is low. In other words, in a case where a volume level of the sound around the output device installation place is very high, the output of the sound is restricted, and only the image is output. Further, in a case where a volume level of the sound around the output device installation place is low, the output of the image is restricted, and only the sound is output.

The volume level of the sound is expressed in units of, for example, dB (decibel). In a case where the volume level of the sound is higher than a predetermined first threshold value, it is determined that “the volume level of the sound is very high”. In a case where the volume level of the sound is equal to or lower than the predetermined first threshold value and higher than a predetermined second threshold value, it is determined that “the volume level of the sound is high”. In a case where the volume level of the sound is equal to or lower than the predetermined second threshold value, it is determined that “the volume level of the sound is low”.

In the example illustrated in FIG. 6B, as the place information, information on the environment around the output device installation place, specifically, an amount of traffic around the output device installation place is determined.

More specifically, in a case where there is much traffic around the output device installation place, it is determined that a volume level of the sound in a case where the output device outputs information is set to be higher than a specific volume, and that the play speeds of the sound and the image are set to fast forwarding. On the other hand, in a case where there is little traffic around the output device installation place, it is determined that a volume level of the sound in a case where the output device outputs information is set to a specific volume, and that the play speeds of the sound and the image are not changed.

The amount of traffic is determined by analyzing the image obtained by the imaging device 28. For example, in a case where the number of persons imaged within a certain time is larger than a predetermined threshold value, it is determined that “there is much traffic”, and in a case where the number of persons imaged within a certain time is equal to or smaller than the predetermined threshold value, it is determined that “there is little traffic”. Further, the fast forwarding of the play speed is, for example, double speed play.

In the example illustrated in FIG. 6C, as the place information, information on the environment around the output device installation place, specifically, a brightness level of the output device installation place is determined.

More specifically, in a case where a brightness level of the output device installation place is high, it is determined that a brightness level of the screen according to the image output is set to be higher than a specific brightness level, and in a case where a brightness level of the output device installation place is low, it is determined that a brightness level of the screen according to the image output is set to the specific brightness level.

The brightness level of the output device installation place is expressed in units of, for example, lux. In a case where a brightness level of the output device installation place is higher than a predetermined threshold value, it is determined that “the output device installation place is bright”, and in a case where a brightness level of the output device installation place is equal to or lower than the predetermined threshold value, it is determined that “the output device installation place is dark”.

In the example illustrated in FIG. 6D, as the place information, information on a region to which the output device installation place belongs is determined.

More specifically, in a case where a region to which the output device installation place belongs is a domestic region, it is determined that domestic content is output, and in a case where a region to which the output device installation place belongs is an overseas region, it is determined that overseas content is output. For example, in Japan, domestic content in Japanese is output. In an overseas country, in addition to overseas content obtained by translating a sound of the domestic content from Japanese into a language of the country and the sound of the domestic content, overseas content that displays, as a subtitle, the language of the country is output.

Here, depending on the domestic region and the overseas region, according to laws of the region, for example, there may be a case where output of a moving image is allowed but output of a sound is prohibited, or there may be a case where a volume of the output sound is restricted. Therefore, according to the region to which the output device installation place belongs, a place information table may be determined such that content of processing prohibited in the region is not included. For example, in a case where outputting a sound in a public place is prohibited in a country X, the place information table may be determined such that only an image is output without outputting a sound.

In the example illustrated in FIG. 7A, as the place information, information on a movement of the output device installation place is determined.

More specifically, in a case where the output device installation place is not moved, it is determined that a volume level of the sound in a case where the output device outputs information is set to a specific volume, and that a size of a text is not changed. On the other hand, in a case where the output device installation place is moved, it is determined that a volume level of the sound in a case where the output device outputs information is set to be higher than the specific volume, and that a size of a text is set to be larger.

As the case where the output device installation place is moved, for example, a case where the output device 24 is embedded in a wall surface of a deck of a truck is exemplified.

In the example illustrated in FIG. 7B, as the place information, information indicating an attribute of the output device installation place is determined.

More specifically, in a case where an attribute of the output device installation place is “office”, it is determined that a volume level of the sound in a case where the output device outputs information is set to a specific volume, and that a size of a text is not changed. In addition, in a case where an attribute of the output device installation place is “hospital”, it is determined that a volume level of the sound in a case where the output device outputs information is set to be lower than the specific volume, and that a size of a text is set to be larger. In other words, for example, a hospital is required to be quiet, and thus a volume level of the sound is set to be low. In addition, there are many elderly persons in hospitals, a size of a text is set to be larger. Further, in a case where an attribute of the output device installation place is “airport”, it is determined that only an image is output. For example, in order to prevent an announcement of a flight in an airport from not being heard, only an image is output without outputting a sound.

In the example illustrated in FIG. 7C, as the place information, information on a user who tends to be at the output device installation place is determined.

More specifically, in a case where there are many office workers at the output device installation place, it is determined that a volume level of the sound in a case where the output device outputs information is set to a specific volume, that a size of a text is not changed, and that a brightness level of the screen is set to a specific brightness level. In a case where there are many elderly persons at the output device installation place, it is determined that a volume level of the sound in a case where the output device outputs information is set to be higher than the specific volume, that a size of a text is set to be larger, and that a brightness level of the screen is set to be higher than the specific brightness level. In a case where there are many foreigners at the output device installation place, it is determined that only an image is output without outputting a sound.

As described above, in the place information table, the place information and the content of the processing of the output device 24 are associated with each other. Thus, based on the place information table, the content of the processing executed in a case where the output device 24 outputs information is determined. Here, the examples illustrated in FIGS. 6A to 7C are merely examples of the place information table. Since there are various types in the place information and the content of the processing, association between the place information and the content of the processing is realized in various forms.

For example, in the example illustrated in FIG. 6A, a volume level of the sound around the output device installation place is associated with the presence or absence of output of each of the sound and the image. On the other hand, a volume level of the sound around the output device installation place may be associated with a volume or a play speed of a sound in a case where the output device outputs information. Further, for example, as the information on an environment around the output device installation place, information such as a lightness level, a temperature, a humidity level, and weather of the output device installation place may be used.

Further, in the examples illustrated in FIGS. 6A to 7C, a plurality of place information tables are illustrated. On the other hand, a plurality of place information tables or only one place information table may be stored in the place information table storage unit 53.

In a case where a plurality of place information tables are stored in the place information table storage unit 53, place information tables to be used are set in advance, or are selected by a user as a sender who sends information by the output device 24. Here, two or more place information tables among the plurality of place information tables may be used, or only one place information table among the plurality of place information tables may be used.

Processing Procedure of Space Management Server

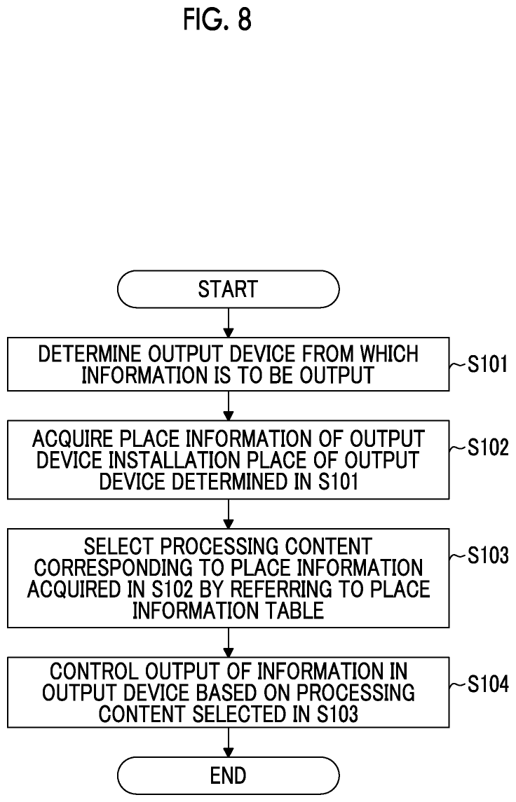

FIG. 8 is a flowchart illustrating an example of a procedure of processing performed by the space management server 5. The processing of FIG. 8 is performed, for example, periodically (for example, every 10 minutes).

In the following, steps of the processing are denoted by a symbol “S”.

First, the place information acquisition unit 51 determines an output device 24 from which information is to be output (S101). For example, the place information acquisition unit 51 determines an output device 24 from which information is to be output, from among the output devices 24 provided in each of the plurality of spaces 2.

Next, the place information acquisition unit 51 acquires place information of the output device installation place of the output device 24 determined in S101 (S102). For example, in a case where the place information is collected from various sensors, the place information collected from the various sensors after processing of S101 may be used, or the place information collected from the various sensors before processing of S101 may be used.

Next, the processing content determination unit 52 selects processing content corresponding to the place information acquired in S102 by referring to the place information table (S103). Next, the output control unit 54 controls output of information in the output device 24 based on the processing content selected in S103 (S104). Then, the processing flow ends.

Specific Example of Processing of Space Management Server

Next, a specific example of the processing of the space management server 5 will be described.

For example, an output device 24 is installed in a certain space 2 by a user as a sender who sends information by the output device 24. Next, the place information acquisition unit 51 acquires the place information of the output device installation place of the output device 24 from the space 2 in which the output device 24 is installed.

Here, as a first example, a case where only the place information table of FIG. 6A is used will be described. In this case, the processing content determination unit 52 determines whether or not a volume level of the sound around the output device installation place is higher than a predetermined first threshold value and a predetermined second threshold value based on information of the sound collected by the sound collection microphone in the space 2, by referring to the place information table of FIG. 6A. In the example, it is assumed that a volume level of the sound around the output device installation place is higher than the predetermined first threshold value. In this case, the processing content determination unit 52 determines outputting only an image.

Next, the output control unit 54 acquires, from the output information storage unit 55, content to be output. The content is stored in the output information storage unit 55 by a sender who sends information by the output device 24. The output control unit 54 controls output of information in the output device 24 so as to output only an image included in the content acquired from the output information storage unit 55. In other words, even in a case where a sound is included in the content acquired from the output information storage unit 55, the output device 24 displays only an image without outputting the sound.

Next, as a second example, a case where a plurality of place information tables are used will be described. Here, it is assumed that two place information tables illustrated in FIGS. 6B and 7A are used. In this case, the processing content determination unit 52 acquires, as place information corresponding to each of the two place information tables, information on traffic around the output device installation place and information on a movement of the output device installation place. By referring to the place information tables of FIGS. 6B and 7A, the content of the processing corresponding to the acquired place information is selected.

In this example, it is assumed that there is much traffic around the output device installation place and the output device installation place is not moved. In this case, the processing content determination unit 52 determines that a volume level of the output sound is set to be higher than a specific volume and a play speed of the output sound is set to fast forwarding based on the place information table of FIG. 6B. Further, the processing content determination unit 52 determines that a volume level of the output sound is set to a specific volume and a size of a text is not changed based on the place information table of FIG. 7A.

Here, in the place information table of FIG. 6B, it is determined that a volume level of the output sound is set to be higher than a specific volume, and in the place information table of FIG. 7A, it is determined that a volume level of the output sound is set to a specific volume. Thus, both of the place information tables cannot be adopted. Therefore, either one of the place information tables is adopted according to a predetermined rule. For example, priorities are set to the place information tables, and the place information table with a higher priority is adopted. For example, in a case where the priority of the place information table illustrated in FIG. 7A is high, the place information table with the high priority is adopted, and it is determined that a volume level of the output sound is set to a specific volume.

Here, the predetermined rule is not limited to the rule based on priorities. For example, a place information table to be prioritized may be determined by a user operation.

Further, in a case where the place information table of FIG. 6B is adopted, all the settings in the place information table of FIG. 6B may not be adopted, and some of the settings in the place information table of FIG. 6B may be adopted. For example, in the place information table of FIG. 6B, even in a case where the setting of “a volume level of the sound is set to be higher than a specific volume” is not adopted, the setting of “a play speed of the sound is set to fast forwarding” may be adopted.

In this example, the processing content determination unit 52 determines that a volume level of the sound is set to a specific volume and a play speed of the sound is set to fast forwarding. Next, the output control unit 54 acquires content to be output from the output information storage unit 55, and controls output of information in the output device 24 such that the acquired content is output with the specific volume and in fast forwarding.

Further, in this example, a user determines the content of the processing of the output device 24 after the output device 24 is installed. On the other hand, a user may determine the content of the processing of the output device 24 before the output device 24 is installed. In this case, for example, a user inputs, as the output device installation place, information on a place where the output device 24 is to be installed. The place information acquisition unit 51 acquires place information of the output device installation place based on the user input. The processing content determination unit 52 determines the content of the processing of the output device 24 based on the place information table.

Processing of Determining Content of Processing Executed in Case where Information is Input to Output Device

In the above-described example, the content of the processing executed in a case where the output device 24 outputs information is determined based on the place information of the output device installation place. Here, in this exemplary embodiment, the content of the processing executed in a case where information is input to the output device 24 may be determined based on the place information of the output device installation place.

The content of the processing executed in a case where information is input to the output device 24 includes, for example, whether or not the output device 24 receives input of information by a touch on the screen, whether or not the output device 24 receives input of information by a voice, and the like. In a case where input of information is received by a voice, for example, the sound collection microphone provided in the output device 24 is used.

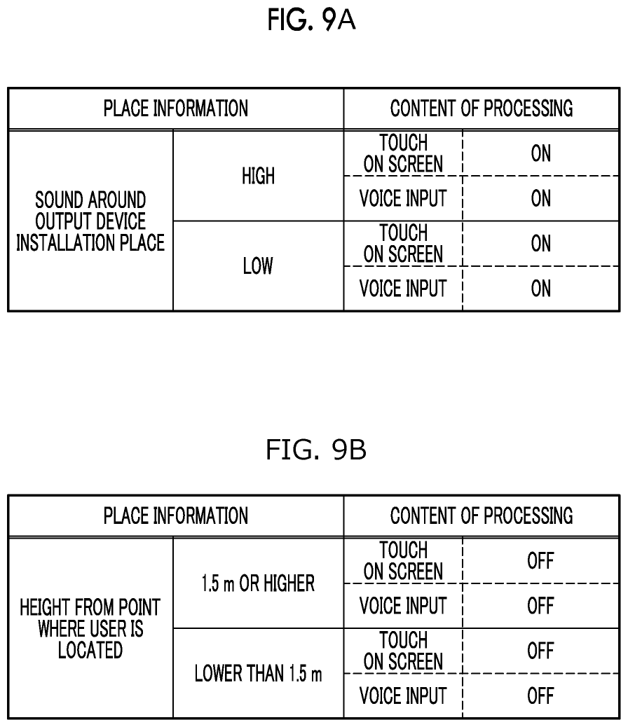

FIGS. 9A and 9B are diagrams illustrating an example of the place information table.

In the example illustrated in FIG. 9A, as the place information, information on the environment around the output device installation place, specifically, a volume level of the sound around the output device installation place is determined.

More specifically, in a case where a volume level of the sound around the output device installation place is high, it may be difficult to accurately collect a voice from a user. Thus, it is determined that a function of receiving input of information by a touch on the screen of the output device 24 is set to ON. Further, it is determined that a function of receiving input of information by a voice in the output device 24 is set to OFF. On the other hand, in a case where a volume level of the sound around the output device installation place is low, it is determined that both of the function of receiving input of information by a touch on the screen of the output device 24 and the function of receiving input of information by a voice in the output device 24 are set to ON.

Further, in the example illustrated in FIG. 9B, as the place information, information on the environment around the output device installation place, specifically, information on a height from a point where a user is located is determined.

More specifically, in a case where the output device 24 is installed at a height of 1.5 m or higher from the point where the user is located, it may be difficult for the user to directly contact the output device 24. Thus, it is determined that a function of receiving input of information by a voice in the output device 24 is set to ON. Further, it is determined that a function of receiving input of information by a touch on the screen of the output device 24 is set to OFF. On the other hand, in a case where the output device 24 is installed at a height lower than 1.5 m from the point where the user is located, it is determined that both of a function of receiving input of information by a voice in the output device 24 and a function of receiving input of information by a touch on the screen of the output device 24 are set to ON.

In this way, the content of the processing executed in a case where information is input to the output device 24 may be determined based on the place information of the output device installation place.

In other words, in this exemplary embodiment, based on the place information of the output device installation place, the space management server 5 may determine both of the content of the processing executed in a case where information is input to the output device 24 and the content of the processing executed in a case where the output device 24 outputs information. Further, based on the place information of the output device installation place, the space management server 5 may determine any one of the content of the processing executed in a case where information is input to the output device 24 and the content of the processing executed in a case where the output device 24 outputs information.

### Other Configuration Examples

Next, other configuration examples of this exemplary embodiment will be described.

Processing of Acquiring Information on Prohibited Processing

In this exemplary embodiment, the place information acquisition unit 51 may acquire information on processing prohibited at the output device installation place. The processing content determination unit 52 may not determine the content of the processing prohibited at the output device installation place, regardless of the place information table.

The content of the prohibited processing includes the content of the processing executed in a case where the output device 24 outputs information and the content of the processing executed in a case where information is input to the output device 24.

For example, it is assumed that displaying a moving image is prohibited by a law in a specific region so as not to hinder traffic in a place where there is much traffic. In this case, for the output device installation place in the specific region, the place information acquisition unit 51 determines whether or not there is much traffic around the output device installation place based on information on the amount of traffic around the output device installation place. In a case where it is determined that there is much traffic around the output device installation place, the processing content determination unit 52 determines, as the content of the processing executed in a case where the output device 24 outputs information, content in which a moving image is not output, regardless of the place information table. The output control unit 54 controls the output device 24 so as not to output a moving image.

Here, instead of prohibiting specific processing, the output control unit 54 may control the output device 24 so as to perform another processing. For example, instead of controlling the output device 24 so as not to output a moving image, the output control unit 54 may control the output device 24 so as to output a still image.

Processing of Notifying Information on Place where Prohibited Processing is Permitted

In this exemplary embodiment, in a case where specific processing is prohibited at the output device installation place, information on a place where the content of the specific processing is permitted may be notified.

For example, in a case where outputting a moving image is prohibited at the output device installation place, the space management server 5 notifies a user as a sender who sends information by the output device 24 of information on a place where traffic is expected to be little, as a place where outputting a moving image is permitted, for example, as a place near the output device installation place.

In this way, by notifying the information on the place where the content of the prohibited processing is permitted, the user as a sender who sends information is guided to install the output device 24 at another place.

Processing of Determining Content of Processing Based on Information on User at Output Device Installation Place

In the above-described example, based on the place information, the content of the processing executed in a case where the output device 24 outputs information and the content of the processing executed in a case where information is input to the output device 24 are determined. Here, in this exemplary embodiment, the content of the processing may be determined based on information on a user at the output device installation place.

For example, a user who is in front of the output device 24, a user who operates the output device 24, or a user who responds to the sound of the output device 24 is detected by the person detecting sensor 26, the imaging device 25, the imaging device 28, or the like. The place information acquisition unit 51 acquires an image of the detected user. In addition, for example, a voice of the user is acquired by the sound collection microphone. The processing content determination unit 52 determines the content of the processing executed in a case where the output device 24 outputs information or the content of the processing executed in a case where information is input to the output device 24, based on the acquired information on the user.

For example, in a case where it is determined that the user is an elderly person or a disabled person based on the acquired image or voice, the processing content determination unit 52 determines that a volume level of the sound in a case where the output device outputs information is set to be higher than a specific volume, that a size of a text is set to be larger, and that a brightness level of the screen is set to be higher than a specific brightness level. In addition, for example, in a case where the user speaks slowly, the processing content determination unit 52 determines that a speed of the output sound is set to be slower than a specific speed. Further, for example, in a case where it is determined that a user hurts his/her arm or a user uses a wand based on the acquired image, the processing content determination unit 52 determines that the function of receiving input of information by a voice in the output device 24 is set to ON.

In this way, the content of the processing executed in a case where the output device 24 outputs information and the content of the processing executed in a case where information is input to the output device 24 may be switched according to the user at the output device installation place.

### Other Examples

In this exemplary embodiment, the place information to be used may be selected from the place information acquired from devices such as various sensors and the place information registered by a user. For example, as the place information of the output device installation place, information on a region to which the output device installation place belongs may be acquired from devices such as various sensors, and a user may also register information on the region. In such a case, for example, one of pieces of the information is preferentially selected by predetermined setting. In addition, for example, a difference between the two pieces of place information may be notified to a user, or the user may be inquired about which information to use. Further, in a case where the two pieces of place information match with each other, the place information may be adopted. For example, in a case where the region of the output device installation place acquired from devices such as various sensors is “overseas country”, and in a case where the region of the output device installation place registered by a user is also “overseas country”, the place information “overseas country” is adopted, and the content of the processing of the output device 24 is determined based on the place information table.

Further, in the above-described example, the output device 24 is installed in the space 2. On the other hand, this exemplary embodiment is not limited to the configuration in which the output device 24 is installed in the space 2. In this exemplary embodiment, the output device 24 may be installed alone without installing the output device 24 in the space 2.

In addition, in the above-described example, the monitor 24A and the speaker 24B are collectively used as the output device 24. On the other hand, this exemplary embodiment is not limited to the configuration. In this exemplary embodiment, the output device 24 may be only the monitor 24A, or may be only the speaker 24B. Further, the output device 24 may be a device other than the monitor 24A and the speaker 24B. For example, as the output device 24, an image forming apparatus that outputs a sheet on which an image is formed, a lighting device that emits light, or the like may be used.

In each of the exemplary embodiments, the CPU 111 is an example of a processor. In the embodiments above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Further, in this exemplary embodiment, some or all of the functions of the space management server 5 may be realized by the output device 24. In other words, the output device 24 can be regarded as an example of an information processing apparatus. In this case, for example, the CPU 211 of the monitor 24A is an example of the processor.

Further, a program for realizing the exemplary embodiments of the present invention can be provided not only by a communication unit but also by being stored in a recording medium such as a CD-ROM.

As described above, various embodiments and modification examples have been described, but these embodiments and modification examples may be combined with each other.

Further, the present disclosure is not limited to the above-described embodiments, and may be implemented in various forms without departing from the scope of the present disclosure.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to
acquire place information as information on a place where an output device that outputs information is installed; and
determine a content of processing executed in a case where the output device outputs information or a content of processing executed in a case where information is input to the output device based on the place information.

2. The information processing apparatus according to claim 1,
wherein the processor
acquires, as the place information, information on an environment around the place where the output device is installed, and
determines the content of processing executed in a case where the output device outputs information or the content of processing executed in a case where information is input to the output device based on the information on the environment.

3. The information processing apparatus according to claim 1,
wherein the processor
acquires, as the place information, information on a region to which the place where the output device is installed belongs, and
determines the content of processing executed in a case where the output device outputs information or the content of processing executed in a case where information is input to the output device based on the information on the region.

4. The information processing apparatus according to claim 1,
wherein the processor
acquires, as the place information, information indicating a movement of the place where the output device is installed, and
determines the content of processing executed in a case where the output device outputs information or the content of processing executed in a case where information is input to the output device based on the movement of the place where the output device is installed.

5. The information processing apparatus according to claim 1,
wherein the processor
acquires, as the place information, information indicating an attribute of the place where the output device is installed, and
determines the content of processing executed in a case where the output device outputs information or the content of processing executed in a case where information is input to the output device based on the information indicating the attribute.

6. The information processing apparatus according to claim 1,
wherein the processor
acquires, as the place information, information on a user who tends to be at the place where the output device is installed, and
determines the content of processing executed in a case where the output device outputs information or the content of processing executed in a case where information is input to the output device based on the information on the user.

7. The information processing apparatus according to claim 1,
wherein the processor determines the content of processing not to be a content of processing prohibited at the place where the output device is installed based on the place information.

8. The information processing apparatus according to claim 7,
wherein the processor notifies information on a place where the content of the prohibited processing is permitted.

9. The information processing apparatus according to claim 1,
wherein the processor determines, as the content of processing executed in a case where the output device outputs information, presence or absence of output of each of a sound and an image based on the place information.

10. The information processing apparatus according to claim 1,
wherein the processor determines, as the content of processing executed in a case where the output device outputs information, a content of processing for a sound output by the output device based on the place information.

11. The information processing apparatus according to claim 10,
wherein the processor determines, as the content of processing for the sound, a volume level of the sound output by the output device based on the place information.

12. The information processing apparatus according to claim 1,
wherein the processor determines, as the content of processing executed in a case where the output device outputs information, a content of processing for an image output by the output device based on the place information.

13. The information processing apparatus according to claim 12,
wherein the processor determines, as the content of processing for the image, a brightness level of a screen according to output of the image by the output device based on the place information.

14. The information processing apparatus according to claim 1,
wherein the processor controls the output device to receive input of information by a touch on a screen of the output device, as the content of processing executed in a case where information is input to the output device, based on the place information.

15. The information processing apparatus according to claim 1,
wherein the processor controls the output device to receive input of information by a voice, as the content of processing executed in a case where information is input to the output device, based on the place information.

16. The information processing apparatus according to claim 1,
wherein the processor is further configured to
detect a user at the place where the output device is installed, and
determine the content of processing executed in a case where the output device outputs information or the content of processing executed in a case where information is input to the output device based on information on the detected user.

17. An information processing apparatus comprising:
a processor configured to
acquire place information as information on an installation place; and
determine a content of processing executed in a case where information is output or a content of processing executed in a case where information is input based on the place information.

18. A non-transitory computer readable medium storing a program causing a computer to execute:
a function of acquiring place information as information on a place where an output device that outputs information is installed; and
a function of determining a content of processing executed in a case where the output device outputs information or a content of processing executed in a case where information is input to the output device based on the place information.

19. A non-transitory computer readable medium storing a program causing a computer to execute:
a function of acquiring place information as information on an installation place; and
a function of determining a content of processing executed in a case where information is output or a content of processing executed in a case where information is input based on the place information.
